(19) United States
(12) Patent Application Publication
(10) Pub. No.: US 2012/0251871 A1
(43) Pub. Date: Oct. 4, 2012

(54) ALL-SOLID-STATE BATTERY

(75) Inventors: Gen Suzuki, Kariya-city (JP); Kenichirou Kami, Takahama-city (JP); Hitoshi Takamura, Sendai-shi (JP); Shinichi Orimo, Sendai-shi (JP); Hideki Maekawa, Sendai-shi (JP); Tamako Maekawa, Sendai-shi (JP)

(73) Assignees: Tohoku University, Sendai-shi (JP); DENSO CORPORATION, Kariya-city (JP)

(21) Appl. No.: 13/432,179

(22) Filed: Mar. 28, 2012

(30) Foreign Application Priority Data
Mar. 29, 2011 (JP) 2011-073266
Mar. 29, 2011 (JP) 2011-073299

(51) Int. Cl. H01M 4/64; H01M 10/056; H01M 10/0562

(52) U.S. Cl. 429/158; 429/211; 429/321; 429/304; 429/323; 429/322; 429/319; 429/306

(57) ABSTRACT

An all-solid-state battery includes: a positive electrode having a positive electrode current collector and a positive electrode layer on the positive electrode current collector; a negative electrode having a negative electrode current collector and a negative electrode layer on the negative electrode current collector; and an electrolyte between the positive and negative electrodes. The electrolyte is made of a first solid-state electrolyte having lithium ionic conductivity. The positive electrode layer includes a base portion and an active material portion. The base portion is made of a second solid-state electrolyte having lithium ionic conductivity in a continuous phase. The active material portion is dispersed in the base portion, and includes a positive electrode active material. The first and second solid-state electrolytes are lithium ionic conductive material having a hydride solid-state electrolyte, respectively.

### CROSS REFERENCE TO RELATED APPLICATIONS

This application is based on Japanese Patent Applications No. 2011-73266 filed on Mar. 29, 2011, and No. 2011-73299 filed on Mar. 29, 2011, the disclosures of which are incorporated herein by reference.

### TECHNICAL FIELD

The present disclosure relates to an all-solid-state battery.

### BACKGROUND

A conventional all-solid-state battery includes three layers, which are a positive electrode, a solid electrolyte and a negative electrode.

When the electrolyte in the all-solid-state battery is solid, the electrolyte does not move since the electrolyte is in a solid state. Accordingly, leakage of the electrolyte does not occur. Thus, even if the electrolyte is not clearly partitioned by a battery casing, the electrolyte is not mixed to other parts. Thus, the construction of the casing and the battery is simplified.

Further, when the battery includes the solid electrolyte, generation of dendrite does not progress even if the negative-electrode active material is made of lithium metal. Thus, the battery has high stability. This battery is disclosed in WO 09/139,382 (corresponding to US 2011/0117440).

In general, the positive-electrode active material is granulous. The positive-electrode active material adsorbs and desorbs a lithium ion via the surface of the positive-electrode active material. The lithium ion is generated by battery reaction. When the secondary battery includes conventional electrolyte, the electrolyte penetrates into space between particles of the positive electrode active material. Thus, the lithium ion is adsorbed and desorbed effectively on the surface of the positive electrode active material.

Further, when the negative electrode active material is made of lithium metal, the volume of the lithium metal is changed according to the progress of the battery reaction. Thus, in general, it is necessary to apply pressure from the outside in order to maintain the contact between the negative electrode and the solid-state electrolyte.

In view of the above point, JP-A-H11-7942 teaches that the surface of the active material is covered with a polymer layer made of conductive polymer having elasticity, so that the volume change is absorbed by the elasticity of the conductive polymer.

However, in the above technique, since the electric conductivity of the solid-state electrolyte is improved when the temperature is high, it is necessary to use the battery at high temperature. When the temperature is high, the polymer layer is easily damaged.

Further, as described in JP-A-2003-59492, when the whole surface of the active material particles is coated with the polymer layer, there is no space for accommodating a deformed part of the polymer, which is caused by the compression when the active material expands. Thus, the expansion of the active material causes the expansion of the electrode. Thus, the expansion of the electrode is not sufficiently restricted. Further, since the whole surface of the active material particles is fully coated with the polymer layer, network in the electric conduction between the active material particles is not sufficient. Thus, the charge/discharge characteristics do not have high efficiency.

### SUMMARY

It is an object of the present disclosure to provide an all-solid-state battery with restricting the reduction of the battery capacity. Further, it is another object of the present disclosure to provide an all-solid-state battery having a negative electrode, of which the volume change is small when charge and discharge process is performed.

According to a first aspect of the present disclosure, an all-solid-state battery includes: a positive electrode having a positive electrode current collector and a positive electrode layer disposed on a surface of the positive electrode current collector; a negative electrode having a negative electrode current collector and a negative electrode layer disposed on a surface of the negative electrode current collector; and an electrolyte disposed between the positive electrode and the negative electrode. The electrolyte is made of a first solid-state electrolyte having lithium ionic conductivity. The positive electrode layer includes a base portion and an active material portion. The base portion is made of a second solid-state electrolyte having lithium ionic conductivity. The base portion is in a continuous phase. The active material portion is dispersed in the base portion, and includes a positive electrode active material. The first solid-state electrolyte and the second solid-state electrolyte are lithium ionic conductive material having a hydride solid-state electrolyte, respectively.

In the above battery, when the active material portion is dispersed in the base portion, i.e., the second solid-state electrolyte, the adsorption and desorption of the lithium ion are smoothly performed. Further, when a part of the positive electrode active material contacting the second solid-state electrolyte is appropriately selected, the part of the positive electrode active material is not reduced although the part contacts the solid-state electrolyte. Thus, the reduction of the battery capacity caused by the reduction of the positive electrode active material with the second solid-state electrolyte is restricted.

According to a second aspect of the present disclosure, an all-solid-state battery includes: a plurality of unit batteries, which are coupled with each other without partitioning each other so that the unit batteries are electrically coupled in series with each other. Each unit battery includes: a positive electrode having a positive electrode current collector having a thin film shape and a positive electrode layer disposed on only one side of the positive electrode current collector; a negative electrode having a negative electrode current collector having a thin film shape and a negative electrode layer disposed on only one side of the negative electrode current collector, which faces the one side of the positive electrode current collector; and an electrolyte disposed between the positive electrode and the negative electrode. The electrolyte is made of a first solid-state electrolyte having lithium ionic conductivity. The positive electrode layer includes a base portion, an active material portion, and a conductive member. The base portion is made of a second solid-state electrolyte having lithium ionic conductivity. The base portion is in a continuous phase. The active material portion is dispersed in the base portion, and includes a positive electrode active material. The first solid-state electrolyte and the second solid-state electrolyte are lithium ionic conductive material having a hydride solid-state electrolyte, respectively.

The above battery provides advantages of the first aspect of the present disclosure. Further, the battery casing may be simplified. Specifically, when the electrolyte is made of the solid-state electrolyte, the short circuit between two unit batteries via the electrolyte is restricted.

According to a third aspect of the present disclosure, an all-solid-state battery includes: a positive electrode having a positive electrode current collector and a positive electrode layer disposed on a surface of the positive electrode current collector; a negative electrode having a negative electrode current collector and a negative electrode layer disposed on a surface of the negative electrode current collector; and an electrolyte disposed between the positive electrode and the negative electrode. The electrolyte is made of a first solid-state electrolyte having lithium ionic conductivity. The negative electrode layer includes a base portion and an active material portion. The base portion of the negative electrode layer is made of a third solid-state electrolyte having lithium ionic conductivity. The base portion of the negative electrode layer is in a continuous phase. The active material portion of the negative electrode layer is dispersed in the base portion of the negative electrode layer, and includes a negative electrode active material. The negative electrode active material includes at least one of negative electrode substances. The negative electrode substances include metallic material for adsorbing and desorbing lithium metal, lithium alloy, lithium metal, alloy material for adsorbing and desorbing lithium, and a compound for adsorbing and desorbing lithium. The first solid-state electrolyte and the third solid-state electrolyte are lithium ionic conductive material having a hydride solid-state electrolyte, respectively.

The volume change of the negative electrode active material caused by the progress of the battery reaction is absorbed in the space of the base portion, so that the volume change of the negative electrode does not substantially occur. For example, this phenomenon will be explained in a case where the base portion of the negative electrode layer includes a space. When the volume of the negative electrode active material increases, the volume change is compensated since the negative electrode active material penetrates into the space. When the volume of the negative electrode active material decreases, the volume change is compensated since the space in the base portion increases. Here, the first and third solid-state electrolytes have large mechanical strength and excellent lithium ionic conduction.

According to a fourth aspect of the present disclosure, an all-solid-state battery includes: a plurality of unit batteries, which are coupled with each other without partitioning each other so that the unit batteries are electrically coupled in series with each other. Each unit battery includes: a positive electrode having a positive electrode current collector having a thin film shape and a positive electrode layer disposed on only one side of the positive electrode current collector; a negative electrode having a negative electrode current collector having a thin film shape and a negative electrode layer disposed on only one side of the negative electrode current collector, which faces the one side of the positive electrode current collector; and an electrolyte disposed between the positive electrode and the negative electrode. The electrolyte is made of a first solid-state electrolyte having lithium ionic conductivity. The negative electrode layer includes a base portion and an active material portion. The base portion of the negative electrode layer is made of a third solid-state electrolyte having lithium ionic conductivity. The base portion of the negative electrode layer is in a continuous phase. The active material portion of the negative electrode layer is dispersed in the base portion of the negative electrode layer, and includes a negative electrode active material. The negative electrode active material includes at least one of negative electrode substances. The negative electrode substances include metallic material for adsorbing and desorbing lithium metal, lithium alloy, lithium metal, alloy material for adsorbing and desorbing lithium, and a compound for adsorbing and desorbing lithium. The first solid-state electrolyte and the third solid-state electrolyte are lithium ionic conductive material having a hydride solid-state electrolyte, respectively.

The above battery provides advantages of the first aspect of the present disclosure. Further, the battery casing may be simplified. Specifically, when the electrolyte is made of the solid-state electrolyte, the short circuit between two unit batteries via the electrolyte is restricted. Further, since the volume change of the negative electrode in each unit battery is restricted, the volume change of a whole of the all-solid-state battery is also restricted.

### BRIEF DESCRIPTION OF THE DRAWINGS

The above and other objects, features and advantages of the present disclosure will become more apparent from the following detailed description made with reference to the accompanying drawings. In the drawings:

FIGS. 1A, 1C and 1E are secondary electron images of mixture of lithium metal and liBH₄ at 500-fold magnification in FIG. 1A, at 1500-fold magnification in FIG. 1C, and at 8000-fold magnification in FIG. 1E, FIGS. 1B, 1D and 1F are reflection electron images of mixture of lithium metal and liBH₄ at 500-fold magnification in FIG. 1B, at 1500-fold magnification in FIG. 1D, and at 8000-fold magnification in FIG. 1F, and FIGS. 1G to 1L are diagrams showing illustrative view of FIGS. 1A to 1F, respectively;

FIG. 2 is a diagram showing a X ray diffraction spectrum pf LiBH₄ and a X ray spectrum of mixture of lithium metal and LiBH₄;

FIG. 3 a diagram showing a graph of electric conductivity;

FIG. 4 is a diagram showing a graph of a discharge capacity; and

FIG. 5 is a diagram showing measurement results of a thickness and a volume of sample batteries.

### DETAILED DESCRIPTION

In order to effectively proceed adsorption and desorption of a lithium ion similar to a conventional secondary battery with using an electrolyte, the present inventors have tried to reduce a conductive resistance of the lithium ion by contacting a solid state electrolyte on the surface of particles of positive electrode active material. Here, the solid state electrolyte is the same as in WO 09/139,382 or a hydride solid state electrolyte.

Specifically, a battery having the positive electrode active material contacting the solid state electrolyte is manufactured. The battery is studied. Then, the present inventors observe the irreversible decomposition, of the positive electrode active material contacting the solid state electrolyte. Further, the battery capacity is reduced.

Thus, the present inventors have found the object of the present disclosure to provide an all-solid-state battery with restricting the reduction of the battery capacity.

In view of the above object, the present inventors have studied, and the present inventors find the reason why the battery capacity is reduced such that the positive electrode active material is reduced by the reduction action of the hydride solid state electrolyte in the solid state electrolyte. Here, the positive electrode active material is oxide positive electrode active material, which is generally used in the lithium battery. The oxide in the oxide positive electrode active material is reduced by the hydride solid state electrolyte, so that the function of the positive electrode active material as active material is reduced. Thus, the battery capacity is reduced.

The present inventors succeed to restrict the reduction of the positive electrode active material even if the positive electrode active material contacts the solid state electrolyte when certain positive electrode active material is used in the battery. Specifically, when a part of the positive electrode active material contacting the solid state electrolyte is made of material, which is not reduced by the solid state electrolyte, the reduction of the positive electrode active material is restricted.

### First Embodiment

An all-solid-state battery according to the present disclosure includes a positive electrode, a negative electrode and an electrolyte. A structure of the all-solid-state battery is not limited. For example, the positive electrode, the negative electrode and the electrolyte are formed to be a sheet shape. Then, the positive electrode sheet, the negative electrode sheet and the electrolyte sheet are stacked, and winded so that a winding type battery is formed. Alternatively, the positive electrode sheet, the negative electrode sheet and the electrolyte sheet are stacked so that a stacking type battery is formed. A shape of each of the positive electrode, the negative electrode and the electrolyte is not limited. For example, each of the positive electrode, the negative electrode and the electrolyte has a sheet shape or a plate shape.

All parts of the all-solid-state battery are in a solid state. Thus, the electrolyte is not substantially displaced. Accordingly, it is not necessary to strictly partition each single battery when multiple single batteries, each of which includes the positive electrode, the negative electrode and the electrolyte, are assembled, i.e., connected to each other so that an assembled battery is formed.

The electrolyte is made of first solid-state electrolyte having lithium ionic conductivity. The electrolyte is disposed between the positive electrode and the negative electrode. The thickness of the electrolyte is not limited. The first solid-state electrolyte is lithium ionic conductivity material having a hydride solid state electrolyte. The first solid-state electrolyte may be made of a single compound. Alternatively, the first solid-state electrolyte may be made of a mixture of multiple compounds. When the first solid-state electrolyte may be made of a mixture of multiple compounds, particles of each compound may be mixed. Alternatively, molecules of each compound may be mixed. Alternatively, each compound may have a sheet shape, and sheets of compounds are stacked. Here, the hydride solid state electrolyte may be LiBH₄, LiAlH₄, Li₃AlH₆, LiBH(Et)₃, LiBH(s-Bu)₃, LiNH₂, Li₂NH, Li[OC(C-141799H₃)₃]₃AlH, Li(OCH₃)₃AlH, or Li(OC₂H₅)₃H. Specifically, the hydride solid state electrolyte may be LiBH₄.

The first solid-state electrolyte may further include at least one of an alkali metal compounds and alkaline-earth metal compounds. The hydride solid state electrolyte and the alkali metal compounds and/or alkaline-earth metal compounds are merely mixed. Alternatively, the hydride solid state electrolyte and the alkali metal compounds and/or alkaline-earth metal compounds may react so that reactant is formed. The hydride solid state electrolyte and the alkali metal compounds and/or alkaline-earth metal compounds are mechanically mixed by a mixing machine or a powder machine. Alternatively, the hydride solid state electrolyte and the alkali metal compounds and/or alkaline-earth metal compounds may be melted, and then, the hydride solid state electrolyte and the alkali metal compounds and/or alkaline-earth metal compounds are mixed. When the lithium ionic conductive material is made of alkali metal compounds and/or alkaline-earth metal compounds, the additive amount of the alkali metal compounds and/or alkaline-earth metal compounds may be in a range between 5% and 100% with respect to the number of moles of the hydride solid state electrolyte. Specifically, the additive amount of the alkali metal compounds and/or alkaline-earth metal compounds may be in a range between 10% and 100% with respect to the number of moles of the hydride solid state electrolyte. The alkali metal compounds may be lithium halide such as LiF, LiCl, LiBr and LiI.

The positive electrode includes a positive electrode current collector and a positive electrode layer disposed on the positive electrode current collector. The positive electrode current collector is made of, for example, metal such as aluminum and stainless-steel having a mesh structure, a punched metal structure, a metal foam structure, a plate shape or a foil shape. The battery casing may function as the positive electrode current collector.

The positive electrode layer includes a base portion and an active material portion. The base portion is made of the second solid-state electrolyte having lithium ionic conductivity in a continuous phase. The active material portion is made of negative electrode active material, and dispersed in the base portion. The positive electrode layer may further include other portions, which are mixed in the base portion. For example, the positive electrode layer may further include a conductive member or a bonding member. The second solid-state electrolyte for providing the base portion may be made of material, which is selected by a group of various materials similar to the first solid-state electrolyte. The second solid-state electrolyte may be made of the same material as the first solid-state electrolyte. Alternatively, the second solid-state electrolyte may be made of material different from the first solid-state electrolyte. When the second solid-state electrolyte is made of the same material as the first solid-state electrolyte, the lithium ionic conductivity between the electrolyte and lithium ions are made preferable.

A method for dispersing the active material portion into the base portion is not limited. For example, after the active material portion is solidified to particles, the second solid-state electrolyte is liquefied so that the second solid-state electrolyte pressurized and filled. Alternatively, the particles of the active material portion and the liquefied second solid-state electrolyte are mixed, or the second solid-state electrolyte is liquefied after the articles of the active material portion and the second solid-state electrolyte are mixed, and then, the active material portion and the second solid-state electrolyte are solidified. Alternatively, both of the active material portion and the second solid-state electrolyte are liquefied and mixed, or both of the active material portion and the second solid-state electrolyte are liquefied after the active material portion and the second solid-state electrolyte are mixed, and then, the active material portion and the second solid-state electrolyte are solidified. Alternatively, after the active material portion and the second solid-state electrolyte are mixed in a solid state, the particles of the active material portion and the second solid-state electrolyte are mixed, or the massive active material portion and the massive second solid-state electrolyte are mixed, they are integrated. In this case, the active material portion and the second solid-state electrolyte are mixed by a conventional method or a crushing method, or the active material portion and the second solid-state electrolyte are mixed without processing when the active material portion and the second solid-state electrolyte are in a particle state. Further, the integration is performed by a compression method or a fusion method. In the fusion method, a part of the interface between the active material portion and the second solid-state electrolyte is melted by adjusting heating temperature and process time, so that the active material portion and the second solid-state electrolyte are welded. The base portion becomes a continuous phase when the mixing condition and the mixing ratio between the second solid state electrolyte for providing the base portion and the positive electrode active material for providing the active material portion are controlled.

The active material portion may be in a continuous phase so that the electric conductivity is improved. The volume average diameter of the particles of the active material portion may be in a range between 6 micrometers and 20 micrometers under a certain use condition when the particles of the active material portion are dispersed in the base portion. The volume average diameter of the particles of the second solid state electrolyte may be in a range between 2 micrometers and 30 micrometers when the particles of the second solid state electrolyte are mixed in a process for forming the positive electrode layer.

The positive electrode layer includes the base portion in the continuous phase and the active material portion. The base portion includes the second solid state electrolyte having the lithium ionic conductivity. The active material portion includes the positive electrode active material, and is dispersed into the base portion. The active material portion is made of one of or a combination of materials, which includes organic positive electrode active material, inorganic positive electrode material, lithium ionic conductor and oxide positive electrode active material coated with carbon material.

The organic positive electrode active material includes at least one of polycyclic aromatic hydrocarbon having polyacene backbone structure such as anthracene, tetracene, pentacene, hexacene and their compound. The inorganic positive electrode active material includes at least one of fluoride perovskite provided by MF₃. M represents Fe, V, Ti, Co or Mn. The lithium ionic conductor includes at least one of LiNbO₃, Li₄Ti₅O₁₂, LiTiO₃, Li₂ZrO₃, Li₄SiO₄ and LiTaO₃. The oxide positive electrode active material includes at least one of lithium compound having layered rock salt type crystal structure or cubic rock salt type crystal structure and lithium compound having spinel type crystal structure. The lithium compound is provided by Li₂₊ₓMn_{1-y}MnO_{2+z}. M represents at least one of transition metal elements other than manganese, Al, Sn and alkali earth metal elements. The subscript x is equal to or larger than −0.5 and equal to or smaller than 0.5, the subscript y is equal to or larger than 0 and smaller than 1, and the subscript z is equal to or larger than 0 and smaller than 0.3. The carbon material includes at least one of or a combination of carbon substances such as carbon black, acetylene black and graphite.

A method for coating the surface of the oxide positive electrode active material with the lithium ionic conductor and the carbon material is not limited. The oxide positive electrode active material, the lithium ionic conductor and the carbon material are solidified to particles, and then, mixed. In this case, the diameter of particles of the oxide positive electrode active material may be larger than the lithium ionic conductor and the carbon material. Alternatively, the particles of the oxide positive electrode active material are mixed into the liquid of the lithium ionic conductor. Then, the solvent is evaporated, so that the lithium ionic conductor is segregated on the surface of the oxide positive electrode active material. Alternatively, a precursor of the carbon material such as high-molecular compound is liquefied, and mixed to the oxide positive electrode active material, and then, the precursor is carbonized so that the surface of the oxide positive electrode active material is coated with the carbon material. When at least a sufficient part of the surface of the oxide positive electrode active material is covered with the carbon material, the reduction of the battery capacity caused by reduction action is restricted. When a part of the surface of the oxide positive electrode active material, which directly contacts the second solid-state electrolyte, is coated with the carbon material, the reduction of the battery capacity is sufficiently improved. When a whole surface of the particles of the oxide positive electrode active material is coated with the carbon material, the reduction of the battery capacity is much improved.

The bonding member functions to hold the active material particles. The bonding material is organic bonding material or inorganic bonding material. For example, the bonding material is polyvinylidene fluoride (PVDF), polyvinylidene chloride, polytetrafluoroethylene (PTFE) or carboxymethyl cellulose (CMC).

The conductive member functions to secure the electric conductivity of the positive electrode. The conductive member includes a least one of or a combination of carbon substances such as carbon black, acetylene black and graphite. Alternatively, the surface of the active material may be coated with the carbon material. A method for coating with the carbon material is not limited. For example, the active substance is mixed with a carbon source material such as a high-molecular compound, and sintered so that the carbon material is carbonized, and the surface of the active material is coated with the carbon material. Here, the high-molecular compound is polyvinyl alcohol, polyvinyl chloride, polyvinylidene chloride, polyvinyl acetate or the like. After the sintering process, the active material with the carbon material may be crushed. The conductive member may function as the carbon material for covering the surface of the oxide positive electrode active material.

The negative electrode includes a negative electrode current collector and a negative electrode layer formed on the surface of the negative electrode current collector. The negative electrode current collector may be made of, for example, metal such as copper and nickel having a mesh structure, a punched metal structure, a metal foam structure, a plate shape or a foil shape. The battery casing may function as the negative electrode current collector.

The negative electrode layer may include only a negative electrode active material. Alternatively, an element may be added to the negative electrode active material.

The negative electrode active material is at least one of or a combination of negative electrode substances, which include metallic material for adsorbing and desorbing lithium metal, lithium alloy, lithium metal, alloy material for adsorbing and desorbing lithium and a compound for adsorbing and desorbing lithium. Here, the alloy material includes metal alloy and alloy of metal and semimetal. Further, the alloy material may include at least one of or a combination of solid solution, eutectic material, eutectic mixture and intermetallic compound. The compound for adsorbing and desorbing lithium includes the carbon material.

The metal element and/or the semimetal element in the metal material and the alloy material are Sn, Pb, Al, In, Si, Zn, Sb, Bi, Cd, Mg, B, Ga, Ge, As, Ag, Zr, Y, Hf and the like. The alloy material and the compound may have a chemical formula of Ma_{f}Mb_{g}Liₕ or MaₛMcₜMdᵤ. Here, Ma represents at least one of metal elements and semimetal elements for alloying with lithium. Mb represents at least one of metal elements and semimetal elements other than lithium and Ma. Mc represents at least one of nonmetal elements. Md represents at least one of metal elements and semimetal elements other than Ma. The subscripts f, g, h, s, y, and u satisfy that the subscript f is larger than zero, the subscript g is equal to or larger than zero, the subscript h is equal to or larger than zero, the subscript s is larger than zero, the subscript t is larger than zero, and the subscript u is equal to or larger than zero.

Specifically, the metal element and/or the semimetal element in the metal material and the alloy material may be a single element, alloy or a compound of group IVB elements in the Short Format of Periodical Table of Elements. For example, the metal element and/or the semimetal element in the metal material and the alloy material may be a single element, alloy or a compound of Si and Sn. The metal material and the alloy material may be crystal or amorphous of a single element, alloy or a compound of Si and Sn.

The negative electrode material for adsorbing and desorbing lithium may be oxide, sulfide and metal compounds including lithium nitride such as LiN3. The oxide may be MnO₂, V₂O₅, V₆O₁₃, NiS or MoS. Alternatively, the oxide having a comparatively low potential and adsorbing and desorbing lithium may be iron oxide, ruthenium oxide, molybdenum oxide, tungsten oxide, titanium oxide, tin oxide and the like. The sulfide may be NiS, MoS and the like.

The negative electrode layer may include a base portion as a constituent element. The base portion is made of a third solid-state electrolyte having lithium ionic conductivity. The base portion in the negative electrode layer is in a continuous phase. An active material portion is dispersed in the base portion. The active material portion is made of negative electrode active substance. In this case, the negative electrode layer includes lithium with a mol fraction equal to or larger than 25 mol %. Specifically, the negative electrode layer includes lithium with a mol fraction equal to or larger than 30 mol %.

When the negative electrode layer includes the base portion and the active material portion, a method for dispersing the active material portion into the base portion is not limited. For example, after the active material portion is solidified to particles, the third solid-state electrolyte is liquefied so that the third solid-state electrolyte pressurized and filled. Alternatively, the particles of the active material portion and the liquefied third solid-state electrolyte are mixed, or the third solid-state electrolyte is liquefied after the articles of the active material portion and the third solid-state electrolyte are mixed, and then, the active material portion and the third solid-state electrolyte are solidified. Alternatively, both of the active material portion and the third solid-state electrolyte are liquefied and mixed, or both of the active material portion and the third solid-state electrolyte are liquefied after the active material portion and the third solid-state electrolyte are mixed, and then, the active material portion and the third solid-state electrolyte are solidified. Alternatively, after the active material portion and the third solid-state electrolyte are mixed in a solid state, the particles of the active material portion and the third solid-state electrolyte are mixed, or the massive active material portion and the massive third solid-state electrolyte are mixed, they are integrated. In this case, the active material portion and the third solid-state electrolyte are mixed by a conventional method or a crushing method, or the active material portion and the third solid-state electrolyte are mixed without processing when the active material portion and the third solid-state electrolyte are in a particle state. Further, the integration is performed by a compression method or a fusion method. In the fusion method, a part of the interface between the active material portion and the third solid-state electrolyte is melted by adjusting heating temperature and process time, so that the active material portion and the third solid-state electrolyte are welded. The base portion becomes a continuous phase when the mixing condition and the mixing ratio between the third solid state electrolyte for providing the base portion and the negative electrode active material for providing the active material portion are controlled.

The active material portion may be in a continuous phase so that the electric conductivity is improved. The volume average diameter of the particles of the active material portion may be in a range between 1 micrometer and 6 micrometers under a certain use condition of the battery when the particles of the active material portion are dispersed in the base portion. The volume average diameter of the particles of the third solid state electrolyte may be in a range between 2 micrometers and 30 micrometers when the particles of the third solid state electrolyte are mixed in a process for forming the negative electrode layer.

If necessary, the negative electrode layer may include a conductive member and a bonding member. The conductive member is added in the negative electrode layer in order to compensate the conductivity when the electric conductivity between the negative electrode active substances and/or between the negative electrode active material and the negative electrode current collector is not sufficient. The conductive member may be the carbon material, the metal material or the alloy material, which do not adsorb and desorb a lithium ion. The bonding member functions to bond between constituent elements in the negative electrode layer and/or between the constituent of the negative electrode layer and the negative electrode current collector. The bonding member may be made of organic bonding material or inorganic bonding material. For example, the bonding material is polyvinylidene fluoride (PVDF), polyvinylidene chloride, polytetrafluoroethylene (PTFE) or carboxymethyl cellulose (CMC).

The third solid-state electrolyte for providing the base portion may be made of material, which is selected by a group of various materials similar to the first and second solid-state electrolytes. The third solid-state electrolyte may be made of the same material as the first and second solid-state electrolytes. Alternatively, the third solid-state electrolyte may be made of material different from the first and second solid-state electrolytes. When the third solid-state electrolyte is made of the same material as the first and second solid-state electrolytes, the lithium ionic conductivity between the electrolyte and lithium ions are made preferable.

The all-solid-state battery according to the present disclosure will be explained with reference to an example embodiment.

(Measurement of Electric Conductivity)

<Manufacturing of Sample>

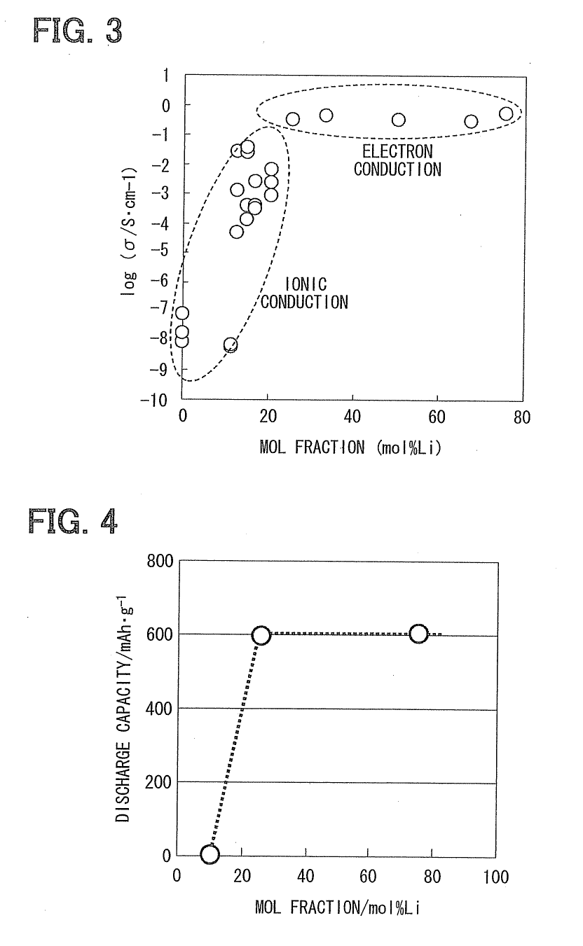

The hydride solid state electrolyte made of LiBH₄ and the negative electrode active material made of lithium metal are prepared for forming the negative electrode layer. Multiple samples are formed to have various mixing ratios between LiBH₄ and the lithium metal, which correspond to the lithium mol fraction (mol %/Li) in FIGS. 3 and 4. As described above, the lithium mol fraction is calculated according to the number of moles of lithium metal in the mixture of lithium metal and LiBH₄.

A manufacturing method of the samples is as follows. First, lithium metal and LiBH₄ are mixed at a certain mixing ratio. The mixing is performed by a physical method. Then, the mixed samples are compressed so that a pellet is formed. The dimensions of the pellet are 10 millimeters of a diameter and 1 millimeter of a thickness. The mixed samples before compression are observed by a scanning electron microscope (i.e., SEM). The secondary electron images and reflection electron images of mixed samples are observed. Since a portion of the reflection electron image, at which an abundance ratio of an element having a large atomic number is high, is observed brighter than other portions, the distribution of LiBH4 is clearly observed.

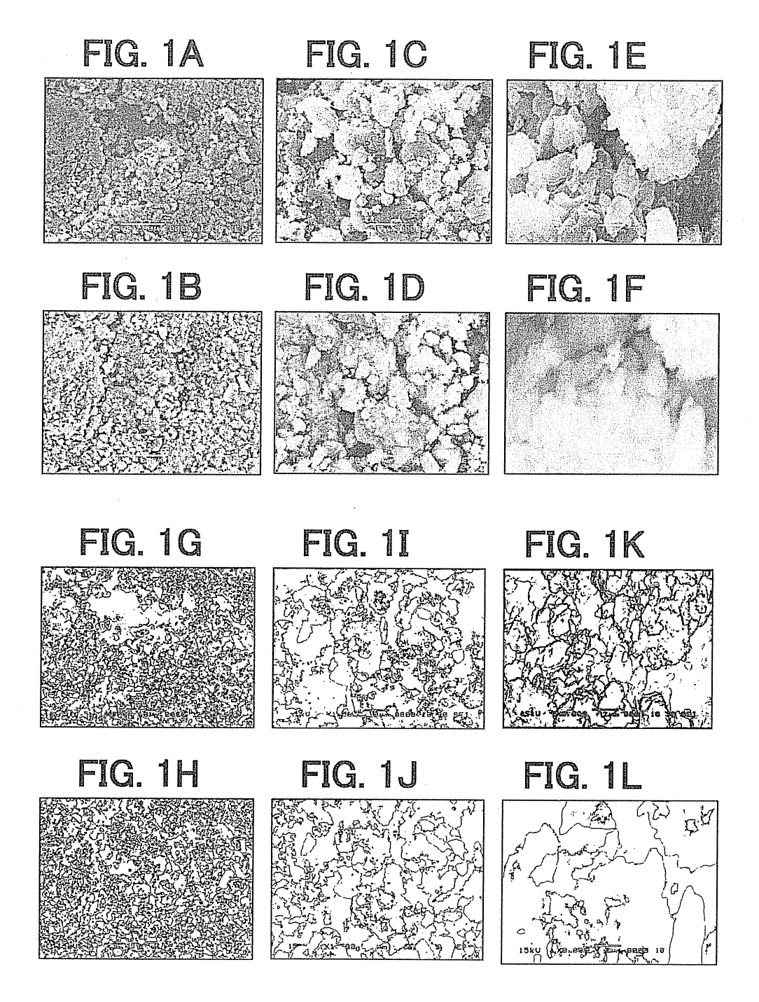

FIGS. 1A to 1L show a SEM observation results. As shown in FIGS. 1A to 1L, the secondary electron images are almost the same as the reflection electron images. Accordingly, LiBH₄ exists uniformly around the lithium metal.

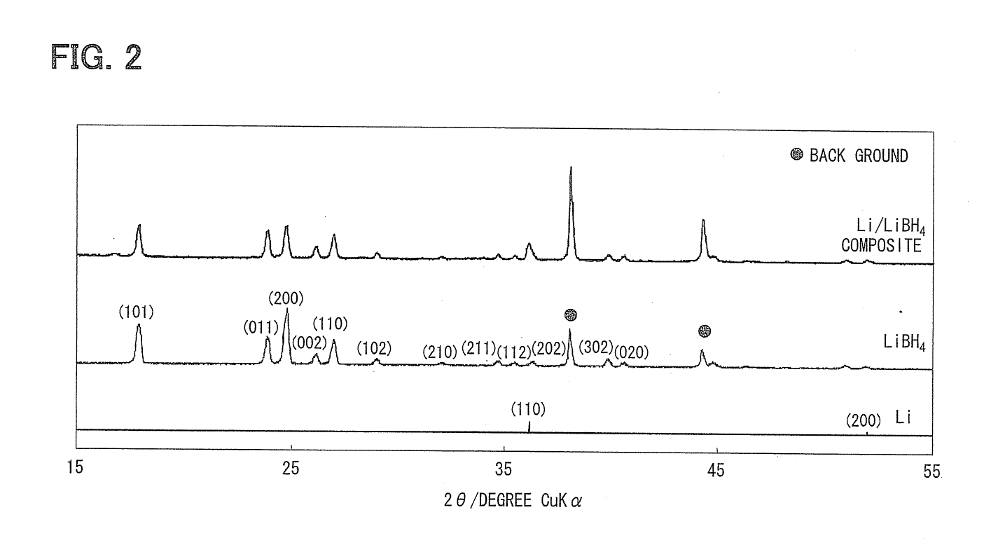

A X-ray diffraction pattern of each of LiBH₄ and the mixed samples (i.e, Li/LiBH₄ composite) is measured. FIG. 2 shows a XRD measurement results. As shown in FIG. 2, when the XRD spectrum of LiBH₄ is compared with the XRD spectrum of the mixed sample, a generated peak and a lost peak (i.e., a different peak) are not observed. Thus, lithium metal and LiBH₄ are simply mixed in the mixed sample. Accordingly, a reaction between lithium metal and LiBH₄, which provides crystal structure change, is not observed.

<Measurements and Results>

The above pellet is sandwiched between electrodes made of platinum, and the electric conductivity is measured. The measurement of the electric conductivity is performed by an alternating impedance method with using an impedance analyzer (SI-1260 made by Solartron).

FIG. 3 shows results of the electric conductivity measurement. As shown in FIG. 3, around the mol fraction of lithium of 20 mol % Li, the ionic conduction is switched to the electron conduction. Specifically, when the Li mol fraction is larger than 25 mol % Li, the electron conduction is observed. That is, when the Li mol fraction exceeds 20 mol % Li, the electron conduction is superior to the ionic conduction.

(Measurement of Charge/Discharge Characteristics)

<Manufacturing of Sample>

The hydride solid state electrolyte made of LiBH₄ and the negative electrode active material made of lithium metal are prepared for forming the negative electrode layer. The mixing ratio between LiBH₄ and the lithium metal corresponds to the lithium mol fraction of 25 mol % Li.

A manufacturing method of the sample is as follows. Lithium metal and LiBH₄ are mixed with a certain mixing ratio. The mixing is performed by a physical method. Then, the mixed sample is compressed so that a pellet is formed. The pellet provides the negative electrode layer as a negative electrode pellet. The dimensions of the pellet are 10 millimeters of a diameter and 0.093 millimeters of a thickness.

Further, the pellet including the first solid-state electrolyte made of LiBH₄ is prepared. The dimensions of the pellet are 10 millimeters of a diameter and 0.76 millimeters of a thickness. Thus, the pellet provides the electrolyte.

The hydride solid state electrolyte made of LiBH₄, the positive electrode active material and the conductive member are mixed with a ration of LiBH4: the positive electrode active material: the conductive member=2:7:1. Then, the mixed sample is compressed so that a pellet for providing the positive electrode layer is formed. The dimensions of the pellet are 10 millimeters of a diameter and 0.13 millimeters of a thickness. The positive electrode active material is made of FeF₃ for providing an example A, LiNiO₂ for providing an example B, and LiNiO₂ for providing an example C. Here, the example A includes the non-organic positive electrode active material. The example B includes the oxide positive electrode active material with coating the surface thereof with Li₄Ti₅O₁₂. The example C includes the oxide positive electrode active material without coating the surface thereof.

The negative electrode layer, the electrolyte and the positive electrode active material are stacked in this order. The stacked sample is sandwiched between electrodes corresponding to the negative electrode current collector and the positive electrode current collector. Thus, an example battery is prepared.

<Measurements and Results>

The above sample batteries are charged with CC-CV and discharged with CC once. The current density is 0.12 mA/cm². The voltage range of the sample A is from 2 volts to 4.5 volts, the voltage range of the samples B and C is from 3 volts to 4.1 volts. Thus, the charge/discharge curve of each sample is measured. The measurement temperature is 120° C.

As a result, in the sample battery C, the reduction action of the positive electrode active material is observed at 3.85 volts, which is lower than the upper limit of charge of 4.1 volts. In the sample battery A, the reduction action of the positive electrode active material is not observed even when the potential reaches the upper limit of charge of 4.5 volts. In the sample battery B, the reduction action of the positive electrode active material is not observed even when the potential reaches the upper limit of charge of 4.1 volts. Accordingly, when the positive electrode active material is made of the non-organic positive electrode active material or the oxide positive electrode active material with coating the surface thereof with Li₄Ti₅O₁₂, the charge/discharge characteristics are high. Specifically, the reduction action of the positive electrode active material caused by the hydride solid state electrolyte does not progress.

(Measurement of Charge/Discharge Characteristics)

<Manufacturing of Sample>

The hydride solid state electrolyte made of LiBH₄ and the negative electrode active material made of lithium metal are prepared for forming the negative electrode layer. The mixing ratio between LiBH₄ and the lithium metal corresponds to the lithium mol fraction of 11 mol % Li, 25 mol % Li or 75 mol % Li, respectively.

A manufacturing method of the sample is as follows. Lithium metal and LiBH₄ are mixed with a certain mixing ratio. The mixing is performed by a physical method. Then, the mixed sample is compressed so that a pellet is formed. The pellet provides the negative electrode layer as a negative electrode pellet. The dimensions of the pellet are 10 millimeters of a diameter and 0.093 millimeters of a thickness.

Further, the pellet including the first solid-state electrolyte made of LiBH₄ is prepared. The dimensions of the pellet are 10 millimeters of a diameter and 0.76 millimeters of a thickness. Thus, the pellet provides the electrolyte. Further, the pellet including the positive electrode active material made of SnCofe is prepared. The dimensions of the pellet are 10 millimeters of a diameter and 0.052 millimeters of a thickness.

The negative electrode layer, the electrolyte and the positive electrode active material are stacked in this order. The stacked sample is sandwiched between electrodes corresponding to the negative electrode current collector and the positive electrode current collector. Thus, an example battery is prepared.

<Measurements and Results>

The above sample batteries are charged with CC-CV and discharged with CC. The current density is 0.65 mA/cm² or 0.13 mA/cm². The voltage range of the sample is from 0.01 volts to 1.5 volts. Thus, the charge/discharge capacity of the samples is measured. The measurement temperature is 120° C.

FIG. 4 shows the charge/discharge capacity of the sample. As shown in FIG. 4, when the lithium mol fraction exceeds 25 mol % Li, the charge/discharge capacity rapidly increases. Specifically, when the lithium mol fraction exceeds 30 mol % Li, the charge/discharge capacity is saturated.

(Volume Change at Charge/Discharge Process)

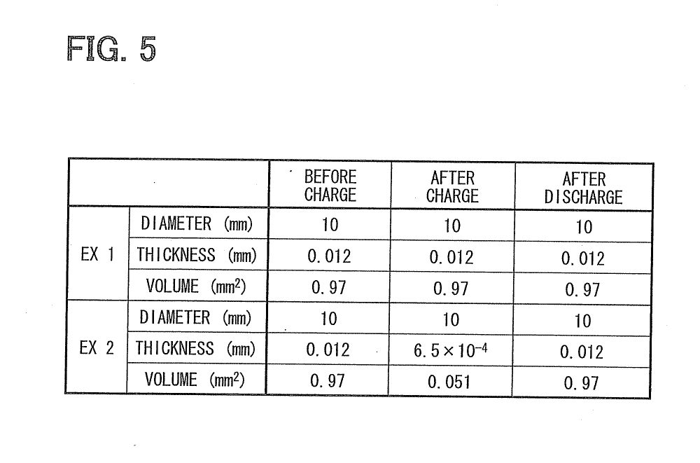

The sample battery (i.e., example No. 1 in FIG. 5) having the negative electrode with the lithium mol fraction of 50 mol % Li and the sample battery (i.e., example No. 2 in FIG. 5) having the negative electrode active material made of a disk of lithium metal (having a diameter of 10 millimeters and a thickness of 0.093 millimeters) are prepared. Then, the charge/discharge test is performed. Then, the thickness of a part of the negative electrode layer corresponding to the positive electrode capacity is measured. FIG. 5 shows a measurement result.

As shown in FIG. 5, in the example No. 1 of the battery having the negative electrode layer made of a pellet of a composite of lithium metal and LiBH₄, the diameter, the thickness and the volume of the battery is not changed before and after charge and discharge. In the example No. 2 of the battery having the negative electrode layer made of a pellet of lithium metal, the diameter, the thickness and the volume of the battery is largely changed before and after charge and discharge. Specifically, the volume of the battery of the example No. 2 is changed by one-twentieth. Accordingly, when the charge and discharge process is repeatedly performed, durability of the electrode may be reduced.

However, in the battery of the example No. 1 as the all-solid-state battery according to the present disclosure, the dimensions of the battery is not substantially changed even when the charge and discharge process is repeatedly performed. Thus, it is not necessary to perform an operation such as pressure applying operation when the battery is used.

Further, in order to provide an all-solid-state battery having a negative electrode, of which the volume change is small when charge and discharge process is performed, the present inventors have studied about the battery. Specifically, when the battery includes the negative electrode having the negative electrode active material, which is dispersed into the solid-state electrolyte made of at least one of lithium ionic conductive materials including the lithium halide and the hydride solid state electrolyte, the volume change of the negative electrode active material is absorbed.

Specifically, when the negative electrode active material, of which the volume is changed according to the battery reaction, is dispersed in the solid-state electrolyte, of which the volume is not changed according to the battery reaction, the volume change of the negative electrode is absorbed in the space provided by the dispersion of the solid-state electrolyte. Thus, the volume of the negative electrode is not substantially changed.

In the above battery, the positive electrode layer desorbs the lithium ion when the battery is changed, and the positive electrode layer absorbs the lithium ion when the battery is discharged. The material of the positive electrode layer is not limited. For example, the positive electrode layer may be made of mixed member of the positive electrode active material, the conductive member and the bonding member. In this case, the mixed member is coated on the surface of the positive electrode current collector, so that the positive electrode layer is formed.

The positive electrode active material is not limited to a specific type of the active material. For example, the positive electrode active material may be a compound including TiS₂, TiS₃, MoS₃, FeS₂, Li₍₁₋ₓ₎MnO₂, Li₍₁₋ₓ₎Mn₂O₄, Li₍₁₋ₓ₎CoO₂, Li₍₁₋ₓ₎NiO₂, V₂O₅ and the like. Alternatively, the positive electrode active material may includes at least one of fluoride perovskite provided by MF₃. M represents Fe, V, Ti, Co or Mn. A subscript x is in a range between 0 and 1. Alternatively, the positive electrode active material may be made of a combination of these compounds. Alternatively, the positive electrode active material may be made of material provided by replacing a part of the transition metal in LiMn₂O₄ or LiNiO₂ with at least one of other transition metals or Li. For example, the positive electrode active material may be made of Li₁₋ₓMn₂₊ₓO₄ or LiNi₁₋ₓCoₓO₂.

The positive electrode active material may be a complex oxide of the transition metal and lithium such as LiMn₂O₄, LiCoO₂ and LiNiO₂. Specifically, since the performance of the active material is excellent, for example, since the diffusion performance of the electron and the lithium ion is excellent, the battery has high charge/discharge efficiency and good cyclic characteristics.

The above disclosure has the following aspects.

According to a first aspect of the present disclosure, an all-solid-state battery includes: a positive electrode having a positive electrode current collector and a positive electrode layer disposed on a surface of the positive electrode current collector; a negative electrode having a negative electrode current collector and a negative electrode layer disposed on a surface of the negative electrode current collector; and an electrolyte disposed between the positive electrode and the negative electrode. The electrolyte is made of a first solid-state electrolyte having lithium ionic conductivity. The positive electrode layer includes a base portion and an active material portion. The base portion is made of a second solid-state electrolyte having lithium ionic conductivity. The base portion is in a continuous phase. The active material portion is dispersed in the base portion, and includes a positive electrode active material. The first solid-state electrolyte and the second solid-state electrolyte are lithium ionic conductive material having a hydride solid-state electrolyte, respectively.

In the above battery, when the active material portion is dispersed in the base portion, i.e., the second solid-state electrolyte, the adsorption and desorption of the lithium ion are smoothly performed. Further, when a part of the positive electrode active material contacting the second solid-state electrolyte is appropriately selected, the part of the positive electrode active material is not reduced although the part contacts the solid-state electrolyte. Thus, the reduction of the battery capacity caused by the reduction of the positive electrode active material with the second solid-state electrolyte is restricted. When the second solid-state electrolyte contacts an element other than the positive electrode active material, the element may be made of a compound, which does not block the conduction of lithium ion and electron.

Here, when the base portion is in a continuous phase, the conduction of the lithium ion, which is adsorbed on and desorbed from the positive electrode active material, is not blocked. Specifically, when the base portion becomes the continuous phase, the blockage of the conduction of the lithium ion is small, so that the output of the battery is made large. Specifically, in view of the conduction of the lithium ion, the continuous phase may provide only one phase without a boundary such as a grain boundary. Further, the continuous phase may provide particles to stick to each other tightly. The composition may not be changed. Alternatively, the change of the composition may be small, and the conduction resistance may be small when the lithium ion conducts. In some cases, a whole of the base portion may be an integrated one body. Alternatively, the whole of the base portion may not be the integrated one body.

According to a second aspect of the present disclosure, an all-solid-state battery includes: a plurality of unit batteries, which are coupled with each other without partitioning each other so that the unit batteries are electrically coupled in series with each other. Each unit battery includes: a positive electrode having a positive electrode current collector having a thin film shape and a positive electrode layer disposed on only one side of the positive electrode current collector; a negative electrode having a negative electrode current collector having a thin film shape and a negative electrode layer disposed on only one side of the negative electrode current collector, which faces the one side of the positive electrode current collector; and an electrolyte disposed between the positive electrode and the negative electrode. The electrolyte is made of a first solid-state electrolyte having lithium ionic conductivity. The positive electrode layer includes a base portion, an active material portion, and a conductive member. The base portion is made of a second solid-state electrolyte having lithium ionic conductivity. The base portion is in a continuous phase. The active material portion is dispersed in the base portion, and includes a positive electrode active material. The first solid-state electrolyte and the second solid-state electrolyte are lithium ionic conductive material having a hydride solid-state electrolyte, respectively.

The above battery provides advantages of the first aspect of the present disclosure. Further, the battery casing may be simplified. Specifically, when the electrolyte is made of the solid-state electrolyte, the short circuit between two unit batteries via the electrolyte is restricted.

Alternatively, the active material portion may be made of at least one of organic positive electrode active substance, inorganic positive electrode active substance, and oxide positive electrode active substance coated with lithium ionic conductor or carbon material. Further, the organic positive electrode active substance may include at least one of polycyclic aromatic hydrocarbons having polyacene backbone structure. The polycyclic aromatic hydrocarbons include anthracene, tetracene, pentacene, hexacene and a compound having at least one of anthracene, tetracene, pentacene, and hexacene. Further, the inorganic positive electrode active substance may include at least one of perovskite fluorides, which are provided by MF₃, and M represents Fe, V, Ti, Co or Mn. Further, the lithium ionic conductor may include at least one of LiNbO₃, Li₄Ti₅O₁₂, LiTiO₃, Li₂ZrO₃, Li₄SiO₄ and LiTaO₃. The oxide positive electrode active material includes at least one of lithium compound having layered rock salt type crystal structure or cubic rock salt type crystal structure and lithium compound having spinel type crystal structure. The lithium compound is provided by Li₂₊ₓMn_{1-y}MyO_{2+z}. M represents at least one of transition metal elements other than manganese, Al, Sn and alkali earth metal elements. A subscript x is equal to or larger than −0.5 and equal to or smaller than 0.5. A subscript y is equal to or larger than 0 and smaller than 1. A subscript z is equal to or larger than 0 and smaller than 0.3. In these cases, since the positive electrode active material has excellent durability, the whole of the all-solid-state battery also has high durability.

Alternatively, the negative electrode layer may include a base portion and an active material portion. The base portion of the negative electrode layer is made of a third solid-state electrolyte having lithium ionic conductivity. The base portion of the negative electrode layer is in a continuous phase. The active material portion of the negative electrode layer is dispersed in the base portion, of the negative electrode layer, and includes a negative electrode active material. The negative electrode active material includes at least one of negative electrode substances. The negative electrode substances include metallic material for adsorbing and desorbing lithium metal, lithium alloy, lithium metal, alloy material for adsorbing and desorbing lithium, and a compound for adsorbing and desorbing lithium. In this case, the volume change in the negative electrode active material caused by the progress of the battery reaction is absorbed by the space in the base portion. Thus, the volume of the negative electrode is not changed. Here, when the negative electrode active material is made of lithium metal only, the volume of the negative electrode changes according to the progress of the charge/discharge process. For example, this phenomenon will be explained in a case where the base portion of the negative electrode layer includes a space. When the volume of the negative electrode active material increases, the volume change is compensated since the negative electrode active material penetrates into the space. When the volume of the negative electrode active material decreases, the volume change is compensated since the space in the base portion increases. In the present disclosure, when the negative electrode active material shrinks, and the space of the base portion increases, the condition for limiting the decrease of the volume of the negative electrode layer, or the condition for restricting the shrinkage of the volume, includes a feature that the third solid-state electrolyte for providing the base portion of the negative electrode layer is in the continuous phase. When the third solid-state electrolyte is in the continuous phase, the third solid-state electrolyte exists continuously in the negative electrode layer so that the volume does not change or the volume change occurs within an allowable range even if the maximum shrinkage of the volume of the negative electrode active material in the negative electrode layer occurs. Further, when the third solid-state electrolyte is in the continuous phase, the blockage of the conduction of the lithium ion becomes small, and therefore, the battery output increases. Specifically, in view of the lithium ionic conduction, the continuous phase provides one phase without a boundary such as a grain boundary. Alternatively, the continuous phase may provide tight contact of particles. The composition may not be changed. Alternatively, the change of the composition may be small, and the conduction resistance may be small when the lithium ion conducts. In some cases, a whole of the base portion may be an integrated one body. Alternatively, the whole of the base portion may not be the integrated one body. Further, even if the space in the negative electrode active material is filled with the solid-state electrolyte, since the negative electrode layer is formed to stop displacing the lithium ion to the negative electrode active material any more, the volume of the negative electrode active material is changed only to be small according to the battery reaction. Thus, the space around the negative electrode active material becomes large so that the volume change of the negative electrode active material is absorbed by the space, and therefore, the volume of the negative electrode layer is not changed.

Alternatively, the negative electrode active material may include a plurality of particles made of the at least one of negative electrode active substances. Specifically, in this case, the base portion is disposed between the particles of the negative electrode active material. Thus, the volume of the negative electrode active material changes within dimensions of the particle. Thus, the volume change of the negative electrode active material does not affect the volume of the negative electrode layer.

Alternatively, the third solid-state electrolyte may be impregnated into a space among the plurality of particles of the negative electrode active material. Specifically, in this case, the volume change attributed to the negative electrode active material is sufficiently restricted. Further, the strength of the base portion provided by the third solid-state electrolyte increases, and the lithium ionic conduction is improved.

Alternatively, at least one of the first to third solid-state electrolytes may include a mixture or a reactant of the hydride solid state electrolyte and an alkali metal compound or an alkaline-earth metal compound. The alkali metal compound and the alkaline-earth metal compound is provided by MXₐ. M represents an alkali metal element or an alkaline-earth metal element. X represents a halogen element, a NR₂ group or a N₂R group. R represents a hydrogen element or an alkyl group. A subscript a is 1 or 2. In this case, the lithium ionic conductive material provided by mixing or reacting at least one of the alkali metal compound and the alkaline-earth metal compound with the hydride solid state electrolyte improves the lithium ionic conduction. Further, the mechanical strength is also improved.

Alternatively, the alkali metal compound may be LiF, LiCl, LiBr, LiI, RbI, or CsI. These alkali metal compound provide high lithium ionic conductivity and sufficient mechanical strength under a condition that the alkali metal compound exists with the hydride solid state electrolyte.

Alternatively, the alkaline-earth metal compound may be BeF₂, BeCl₂, BeBr₂, BeI₂, MgF₂, MgCl₂, MgBr₂, MgI₂, CaF₂, CaCl₂, CaBr₂, CaI₂, SrF₂, SrCl₂, SrBr₂, SrI₂, BaF₂, BaCl₂, BaBr₂, or BaI₂. These alkaline-earth metal compound provide high lithium ionic conductivity and sufficient mechanical strength under a condition that the alkaline-earth metal compound exists with the hydride solid state electrolyte.

Alternatively, the hydride solid-state electrolyte may be LiBH₄, LiAlH₄, Li₃AlH₆, LiBH(Et)₃, LiBH(s-Bu)₃, LiNH₂, Li₂NH, Li[OC(C-141799H₃)₃]₃AlH, Li(OCH₃)₃AlH, or Li(OC₂H₅)₃H. These hydride solid-state electrolytes provide high lithium ionic conductivity and sufficient mechanical strength under a condition that the alkaline metal compound exists with the hydride solid state electrolyte.

Alternatively, the first to third solid-state electrolytes may be made of the same lithium ionic conductive material. In this case, the lithium ionic conduction between the positive electrode layer and the electrolyte is improved, and further, the lithium ionic conduction between the negative electrode layer and the electrolyte is improved. Specifically, when the first to third solid-state electrolytes are in the continuous phase, the lithium ionic conduction is much improved.

Alternatively, the hydride solid-state electrolyte may include LiBH₄.

According to a third aspect of the present disclosure, an all-solid-state battery includes: a positive electrode having a positive electrode current collector and a positive electrode layer disposed on a surface of the positive electrode current collector; a negative electrode having a negative electrode current collector and a negative electrode layer disposed on a surface of the negative electrode current collector; and an electrolyte disposed between the positive electrode and the negative electrode. The electrolyte is made of a first solid-state electrolyte having lithium ionic conductivity. The negative electrode layer includes a base portion and an active material portion. The base portion of the negative electrode layer is made of a third solid-state electrolyte having lithium ionic conductivity. The base portion of the negative electrode layer is in a continuous phase. The active material portion of the negative electrode layer is dispersed in the base portion of the negative electrode layer, and includes a negative electrode active material. The negative electrode active material includes at least one of negative electrode substances. The negative electrode substances include metallic material for adsorbing and desorbing lithium metal, lithium alloy, lithium metal, alloy material for adsorbing and desorbing lithium, and a compound for adsorbing and desorbing lithium. The first solid-state electrolyte and the third solid-state electrolyte are lithium ionic conductive material having a hydride solid-state electrolyte, respectively.

The volume change of the negative electrode active material caused by the progress of the battery reaction is absorbed in the space of the base portion, so that the volume change of the negative electrode does not substantially occur. For example, this phenomenon will be explained in a case where the base portion of the negative electrode layer includes a space. When the volume of the negative electrode active material increases, the volume change is compensated since the negative electrode active material penetrates into the space. When the volume of the negative electrode active material decreases, the volume change is compensated since the space in the base portion increases. In the present disclosure, when the negative electrode active material shrinks, and the space of the base portion increases, the condition for limiting the decrease of the volume of the negative electrode layer, or the condition for restricting the shrinkage of the volume, includes a feature that the third solid-state electrolyte for providing the base portion of the negative electrode layer is in the continuous phase. When the third solid-state electrolyte is in the continuous phase, the third solid-state electrolyte exists continuously in the negative electrode layer so that the volume does not change or the volume change occurs within an allowable range even if the maximum shrinkage of the volume of the negative electrode active material in the negative electrode layer occurs. Further, when the third solid-state electrolyte is in the continuous phase, the blockage of the conduction of the lithium ion becomes small, and therefore, the battery output increases. Specifically, in view of the lithium ionic conduction, the continuous phase provides one phase without a boundary such as a grain boundary. Alternatively, the continuous phase may provide tight contact of particles. The composition may not be changed. Alternatively, the change of the composition may be small, and the conduction resistance may be small when the lithium ion conducts. In some cases, a whole of the base portion may be an integrated one body. Alternatively, the whole of the base portion may not be the integrated one body. Further, even if the space in the negative electrode active material is filled with the solid-state electrolyte, since the negative electrode layer is formed to stop displacing the lithium ion to the negative electrode active material any more, the volume of the negative electrode active material is changed only to be small according to the battery reaction. Thus, the space around the negative electrode active material becomes large so that the volume change of the negative electrode active material is absorbed by the space, and therefore, the volume of the negative electrode layer is not changed. Here, the first and third solid-state electrolytes have large mechanical strength and excellent lithium ionic conduction.

According to a fourth aspect of the present disclosure, an all-solid-state battery includes: a plurality of unit batteries, which are coupled with each other without partitioning each other so that the unit batteries are electrically coupled in series with each other. Each unit battery includes: a positive electrode having a positive electrode current collector having a thin film shape and a positive electrode layer disposed on only one side of the positive electrode current collector; a negative electrode having a negative electrode current collector having a thin film shape and a negative electrode layer disposed on only one side of the negative electrode current collector, which faces the one side of the positive electrode current collector; and an electrolyte disposed between the positive electrode and the negative electrode. The electrolyte is made of a first solid-state electrolyte having lithium ionic conductivity. The negative electrode layer includes a base portion and an active material portion. The base portion of the negative electrode layer is made of a third solid-state electrolyte having lithium ionic conductivity. The base portion of the negative electrode layer is in a continuous phase. The active material portion of the negative electrode layer is dispersed in the base portion of the negative electrode layer, and includes a negative electrode active material. The negative electrode active material includes at least one of negative electrode substances. The negative electrode substances include metallic material for adsorbing and desorbing lithium metal, lithium alloy, lithium metal, alloy material for adsorbing and desorbing lithium, and a compound for adsorbing and desorbing lithium. The first solid-state electrolyte and the third solid-state electrolyte are lithium ionic conductive material having a hydride solid-state electrolyte, respectively.

The above battery provides advantages of the first aspect of the present disclosure. Further, the battery casing may be simplified. Specifically, when the electrolyte is made of the solid-state electrolyte, the short circuit between two unit batteries via the electrolyte is restricted. Further, since the volume change of the negative electrode in each unit battery is restricted, the volume change of a whole of the all-solid-state battery is also restricted.

Alternatively, a mol fraction of lithium in the negative electrode layer may be equal to or larger than 25 mol % under a condition that the battery is used. In this case, the battery has high charge/discharge capacity and high output density. Here, the mol fraction of lithium is calculated by the number of moles of lithium metal in the mixture of lithium metal and LiBH₄.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An all-solid-state battery comprising:
a positive electrode having a positive electrode current collector and a positive electrode layer disposed on a surface of the positive electrode current collector;
a negative electrode having a negative electrode current collector and a negative electrode layer disposed on a surface of the negative electrode current collector; and
an electrolyte disposed between the positive electrode and the negative electrode,
wherein the electrolyte is made of a first solid-state electrolyte having lithium ionic conductivity,
wherein the positive electrode layer includes a base portion and an active material portion,
wherein the base portion is made of a second solid-state electrolyte having lithium ionic conductivity,
wherein the base portion is in a continuous phase,
wherein the active material portion is dispersed in the base portion, and includes a positive electrode active material, and
wherein the first solid-state electrolyte and the second solid-state electrolyte are lithium ionic conductive material having a hydride solid-state electrolyte, respectively.

2. An all-solid-state battery comprising:
a plurality of unit batteries, which are coupled with each other without partitioning each other so that the unit batteries are electrically coupled in series with each other,
wherein each unit battery includes:
a positive electrode having a positive electrode current collector having a thin film shape and a positive electrode layer disposed on only one side of the positive electrode current collector;
a negative electrode having a negative electrode current collector having a thin film shape and a negative electrode layer disposed on only one side of the negative electrode current collector, which faces the one side of the positive electrode current collector; and
an electrolyte disposed between the positive electrode and the negative electrode,
wherein the electrolyte is made of a first solid-state electrolyte having lithium ionic conductivity,
wherein the positive electrode layer includes a base portion, an active material portion, and a conductive member,
wherein the base portion is made of a second solid-state electrolyte having lithium ionic conductivity,
wherein the base portion is in a continuous phase,
wherein the active material portion is dispersed in the base portion, and includes a positive electrode active material, and
wherein the first solid-state electrolyte and the second solid-state electrolyte are lithium ionic conductive material having a hydride solid-state electrolyte, respectively.

3. The all-solid-state battery according to claim 1,
wherein the active material portion is made of at least one of organic positive electrode active substance, inorganic positive electrode active substance, and oxide positive electrode active substance coated with lithium ionic conductor or carbon material.

4. The all-solid-state battery according to claim 3,
wherein the organic positive electrode active substance includes at least one of polycyclic aromatic hydrocarbons having polyacene backbone structure, and
wherein the polycyclic aromatic hydrocarbons include anthracene, tetracene, pentacene, hexacene and a compound having at least one of anthracene, tetracene, pentacene, and hexacene.

5. The all-solid-state battery according to claim 3,
wherein the inorganic positive electrode active substance includes at least one of perovskite fluorides, which are provided by MF₃, and
wherein M represents Fe, V, Ti, Co or Mn.

6. The all-solid-state battery according to claim 3,
wherein the lithium ionic conductor includes at least one of LiNbO₃, Li₄Ti₅O₁₂, LiTiO₃, Li₂ZrO₃, Li₄SiO₄ and LiTaO₃,
wherein the oxide positive electrode active material includes at least one of lithium compound having layered rock salt type crystal structure or cubic rock salt type crystal structure and lithium compound having spinel type crystal structure,
wherein the lithium compound is provided by Li₂₊ₓMn_{1-y}MyO_{2+z},
wherein M represents at least one of transition metal elements other than manganese, Al, Sn and alkali earth metal elements,
wherein a subscript x is equal to or larger than −0.5 and equal to or smaller than 0.5,
wherein a subscript y is equal to or larger than 0 and smaller than 1,
wherein a subscript z is equal to or larger than 0 and smaller than 0.3.

7. The all-solid-state battery according to claim 1,
wherein the negative electrode layer includes a base portion and an active material portion,
wherein the base portion of the negative electrode layer is made of a third solid-state electrolyte having lithium ionic conductivity,
wherein the base portion of the negative electrode layer is in a continuous phase,
wherein the active material portion of the negative electrode layer is dispersed in the base portion of the negative electrode layer, and includes a negative electrode active material,
wherein the negative electrode active material includes at least one of negative electrode substances, and
wherein the negative electrode substances include metallic material for adsorbing and desorbing lithium metal, lithium alloy, lithium metal, alloy material for adsorbing and desorbing lithium, and a compound for adsorbing and desorbing lithium.

8. The all-solid-state battery according to claim 7,
wherein the negative electrode active material includes a plurality of particles made of the at least one of negative electrode active substances.

9. The all-solid-state battery according to claim 8,
wherein the third solid-state electrolyte is impregnated into a space among the plurality of particles of the negative electrode active material.

10. The all-solid-state battery according to claim 7,
wherein at least one of the first to third solid-state electrolytes includes a mixture or a reactant of the hydride solid state electrolyte and an alkali metal compound or an alkaline-earth metal compound,
wherein the alkali metal compound and the alkaline-earth metal compound is provided by MXₐ,
wherein M represents an alkali metal element or an alkaline-earth metal element,
wherein X represents a halogen element, a NR₂ group or a N₂R group,
wherein R represents a hydrogen element or an alkyl group, and
wherein a subscript a is 1 or 2.

11. The all-solid-state battery according to claim 10,
wherein the alkali metal compound is LIF, LiCl, LiBr, LiI, RbI, or CsI.

12. The all-solid-state battery according to claim 10,
wherein the alkaline-earth metal compound is BeF₂, BeCl₂, BeBr₂, BeI₂, MgF₂, MgCl₂, MgBr₂, MgI₂, CaF₂, CaCl₂, CaBr₂, CaI₂, SrF₂, SrCl₂, SrBr₂, SrI₂, BaF₂, BaCl₂, BaBr₂, or BaI₂.

13. The all-solid-state battery according to claim 1,
wherein the hydride solid-state electrolyte is LiBH₄, LiAlH₄, Li₃AlH₆, LiBH(Et)₃, LiBH(s-Bu)₃, LiNH₂, Li₂NH, Li[OC(C-141799H₃)₃]₃AlH, Li(OCH₃)₃AlH, or Li(OC₂H₅)₃H.

14. The all-solid-state battery according to claim 7,
wherein the first to third solid-state electrolytes are made of the same lithium ionic conductive material.

15. The all-solid-state battery according to claim 1,
wherein the hydride solid-state electrolyte includes LiBH₄.

16. An all-solid-state battery comprising:
a positive electrode having a positive electrode current collector and a positive electrode layer disposed on a surface of the positive electrode current collector;
a negative electrode having a negative electrode current collector and a negative electrode layer disposed on a surface of the negative electrode current collector; and
an electrolyte disposed between the positive electrode and the negative electrode,
wherein the electrolyte is made of a first solid-state electrolyte having lithium ionic conductivity,
wherein the negative electrode layer includes a base portion and an active material portion,
wherein the base portion of the negative electrode layer is made of a third solid-state electrolyte having lithium ionic conductivity,
wherein the base portion of the negative electrode layer is in a continuous phase,
wherein the active material portion of the negative electrode layer is dispersed in the base portion of the negative electrode layer, and includes a negative electrode active material,
wherein the negative electrode active material includes at least one of negative electrode substances, and
wherein the negative electrode substances include metallic material for adsorbing and desorbing lithium metal, lithium alloy, lithium metal, alloy material for adsorbing and desorbing lithium, and a compound for adsorbing and desorbing lithium, and
wherein the first solid-state electrolyte and the third solid-state electrolyte are lithium ionic conductive material having a hydride solid-state electrolyte, respectively.

17. An all-solid-state battery comprising:
a plurality of unit batteries, which are coupled with each other without partitioning each other so that the unit batteries are electrically coupled in series with each other,
wherein each unit battery includes:
a positive electrode having a positive electrode current collector having a thin film shape and a positive electrode layer disposed on only one side of the positive electrode current collector;
a negative electrode having a negative electrode current collector having a thin film shape and a negative electrode layer disposed on only one side of the negative electrode current collector, which faces the one side of the positive electrode current collector; and
an electrolyte disposed between the positive electrode and the negative electrode,
wherein the electrolyte is made of a first solid-state electrolyte having lithium ionic conductivity,
wherein the negative electrode layer includes a base portion and an active material portion,
wherein the base portion of the negative electrode layer is made of a third solid-state electrolyte having lithium ionic conductivity,
wherein the base portion of the negative electrode layer is in a continuous phase,
wherein the active material portion of the negative electrode layer is dispersed in the base portion of the negative electrode layer, and includes a negative electrode active material,
wherein the negative electrode active material includes at least one of negative electrode substances, and
wherein the negative electrode substances include metallic material for adsorbing and desorbing lithium metal, lithium alloy, lithium metal, alloy material for adsorbing and desorbing lithium, and a compound for adsorbing and desorbing lithium, and
wherein the first solid-state electrolyte and the third solid-state electrolyte are lithium ionic conductive material having a hydride solid-state electrolyte, respectively.

18. The all-solid-state battery according to claim 16,
wherein a mol fraction of lithium in the negative electrode layer is equal to or larger than 25 mol % under a condition that the battery is used.

19. The all-solid-state battery according to claim 16,
wherein at least one of the first and third solid-state electrolytes includes a mixture or a reactant of the hydride solid state electrolyte and an alkali metal compound or an alkaline-earth metal compound,
wherein the alkali metal compound and the alkaline-earth metal compound is provided by MXₐ,
wherein M represents an alkali metal element or an alkaline-earth metal element,
wherein X represents a halogen element, a NR₂ group or a N₂R group,
wherein R represents a hydrogen element or an alkyl group, and
wherein a subscript a is 1 or 2.

20. The all-solid-state battery according to claim 19,
wherein the alkali metal compound is LiF, LiCl, LiBr, LiI, RbI, or CsI.

21. The all-solid-state battery according to claim 19,
wherein the alkaline-earth metal compound is BeF₂, BeCl₂, BeBr₂, BeI₂, MgF₂, MgCl₂, MgBr₂, MgI₂, CaF₂, CaCl₂, CaBr₂, CaI₂, SrF₂, SrCl₂, SrBr₂, SrI₂, BaF₂, BaCl₂, BaBr₂, or BaI₂.

22. The all-solid-state battery according to claim 16,
wherein the hydride solid-state electrolyte is LiBH₄, LiAlH₄, Li₃AlH₆, LiBH(Et)₃, LiBH(s-Bu)₃, LINH₂, Li₂NH, Li[OC(C-141799H₃)₃]₃AlH, Li(OCH₃)₃AlH, or Li(OC₂H₅)₃H.

23. The all-solid-state battery according to claim 16,
wherein the first and third solid-state electrolytes are made of the same lithium ionic conductive material.

24. The all-solid-state battery according to claim 16,
wherein the negative electrode active material includes a plurality of particles made of the at least one of negative electrode active substances.

25. The all-solid-state battery according to claim 24,
wherein the third solid-state electrolyte is impregnated into a space among the plurality of particles of the negative electrode active material.

26. The all-solid-state battery according to claim 16,
wherein the hydride solid-state electrolyte includes LiBH₄.
